(19) United States
(12) Patent Application Publication
(10) Pub. No.: US 2007/0111192 A1
(43) Pub. Date: May 17, 2007

(54) Detection of protein interactions

(76) Inventors: John Nelson, Belfast (GB); William Paul Duprex, Lisburn (GB); Neil McFerran, Belfast (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/579,641

(22) PCT Filed: Nov. 22, 2004
(86) PCT No.: PCT/GB04/04928

§ 371 Date: Dec. 8, 2006

(30) Foreign Application Priority Data
Nov. 21, 2003 (GB) 0327143.4

(51) Int. Cl. C40B 40/08; C40B 40/10

(52) U.S. Cl. 435/4; 435/6

(57) ABSTRACT

The present invention relates to a method of detecting interactions, particularly peptide to peptide interactions, using fluorescence. Nucleic acids encoding fragments of fluorescent protein, a peptide of interest and a linker portion of different lengths interposed between the peptide of interest and a fragment of fluorescent protein is provided together with a peptide-interaction system and methods of using the same.

### FIELD OF THE INVENTION

The present invention relates to a method of detecting interactions. In particular, but not exclusively, the invention relates to a method of detecting protein to protein interactions using fluorescence.

### BACKGROUND TO THE INVENTION

Protein to protein interactions play a key role in many biological processes including the assembly of enzymes, protein homo/hetero-oligomers, regulation of intracellular transport, gene expression, receptor-ligand interactions, entry of pathogens into the cell and the action of small molecules or drugs.

Identification and characterisation of macromolecular interactions can be performed using co-immunoprecipitation from cell lysates and solubilised membranes. However, this technique requires specific antibodies for both capture and identification of proteins and may further require the use of detergent to disrupt interactions.

More recently non-invasive techniques have been developed to determine protein to protein interactions.

Such non-invasive techniques were pioneered by the yeast two hybrid method which is based on complementation of a split yeast nuclear transcription factor.

The use of yeast expression systems to identify mammalian protein-to-protein interaction suffers from a number of disadvantages. Certain post-translational modifications, that are normally critical to mammalian protein interactions, cannot be achieved by expression and/or post translational modification of proteins by yeast cells. For example, tyrosine phosphorylation is the key to many mammalian protein binding events involved in signal transduction. However, the yeast genome contains no tyrosine kinase genes so phosphotyrosine-dependent protein interactions cannot be accessed in yeast two hybrid studies.

Furthermore, in yeast two hybrid screening the protein complex must be able to translocate to the nucleus to cause expression of the reporter gene or cause downstream events to trigger the expression of a reporter gene. Thus, proteins that are excluded from the yeast nucleus will not be accessible to this screening method.

Further methods such as protein complementation and the split ubiquitin method utilise similar underlying concepts to the yeast two hybrid method in that the interaction of two proteins (a bait protein and prey protein) act to express a reporter gene, the reporter gene allowing the interaction event to be visualised as a detectable signal.

Such methods which utilise the expression of a reporter gene such as an enzyme to produce a detectable signal suffer from the disadvantage that the location of the protein complexes being detected cannot be accurately visualised in the cell.

Recently the technique of fluorescence energy transfer (FRET) has been used to determine protein to protein interactions. In this technique the interaction of two fluorophores, an absorbing moiety and a fluoresceing moiety, indicates their close spatial proximity. For protein to protein interaction monitoring, the absorbing moiety is added to a first protein partner and the fluorescing moiety is added to a second binding partner. Provided the emission spectrum of the absorbing moiety overlaps the excitation spectrum of the fluorescing moiety and both moieties are within 100 Å of each other FRET will occur.

FRET can utilise mutations in the sequence of green fluorescent protein (GFP) from the jellyfish Aequorea victoria which have been shown to cause variations in the spectral emission of GFP. These mutations give rise to variants of GFP such as Yellow Fluorescent Protein (YFP), as well as cyan (CFP) and blue (BFP) fluorescing variants. This technique uses fluorescent energy transfer between these colour variants of GFP fused to interacting proteins. Unfortunately, this method requires overexpression of the GFP fusion proteins to allow quantification of the small changes in fluorescence. Related methods to FRET require the use of irreversible photobleaching (FRAP) or expensive instruments capable of measuring fluorescence lifetime imaging (FLIM).

It has recently been shown that fluorescence can be generated following the functional association of two separate fragments of the GFP molecule (hapto-GFPs) when driven by the interaction of a pair of proteins fused via a linker to the new C′ and N′ termini of the hapto-GFPs. (Ghosh et al, (2000); Hu et al, (2002).

Whilst the methods disclosed by these documents may be used in determining whether interaction occurs between specific proteins they are not suitable for screening the interactions of peptides of which the mode of binding is unknown.

Conventionally, the length of the linkers used is chosen from a knowledge the peptides whose interaction with each other is being tested. From this knowledge a suitable linker length which allows association of the fragments of fluorescent protein following the peptide interaction can be chosen. A knowledge of the peptides of interest or their mode of binding to each other has been considered to be required.

For example, if the peptides interact with each other such that they form an anti-parallel complex (hapto-GFP-N¹->C¹:binding to :C²->N²-hapto-GFP) and the fluorescent fragments are orientated such that they are directed away from each other in space then long linkers would be required to allow the fragments of fluorescent protein to interact. If short linkers were used, despite interaction of the peptides of interest occurring, then this might not be detected as the fragments would be prevented from associating with each other due to the stereochemical hindrance from the linkers. This would result in a false negative result in an assay method.

### SUMMARY OF THE INVENTION

The inventors through extensive work have developed a robust system which overcomes many of the problems of the prior art and provides for the first time a general screening method which may used to determine interaction between unknown peptides.

According to a first aspect of the invention there is provided a protein interaction system comprising
a plurality of bait fusion proteins, each fusion protein comprising (i) a first fragment of fluorescent protein, a first peptide of interest and a linker portion interposed between the first peptide and first fluorescent fragment; wherein the linker portions of each bait fusion protein are of different lengths, and the first peptide of interest of each bait fusion protein is identical to the first peptide of interest in each of the other bait fusion proteins,
and (ii) at least one prey fusion protein comprising a fragment of fluorescent protein complementary to said first fragment of fluorescent protein, a second peptide of interest and a second linker portion interposed between the complementary fragment and the second peptide;
wherein, on interaction of a first peptide of interest with a second peptide of interest, the fragments of the fluorescent protein functionally associate to promote fluorescence.

Thus, fluorescence will only be promoted when peptides of interest of bait and prey fusion proteins, having suitable linker lengths to allow the respective fluorescent protein fragments to associate, are used.

The provision of a peptide of interest linked to a fluorescent fragment via a range of linker lengths is advantageous over a single linker length as such a range maximises the chances of an interaction between peptides of interest being detected and minimises the chances that the fluorescent fragments cannot associate with each other due to stereochemical hindrance or that the linkers are too flexible (too long) and thus the fragments are not being brought together in space despite the proteins of interest interacting.

The provision of fusion proteins wherein the fusion proteins comprise linkers of different lengths allows for the first time the provision of a general method which can be used to study the interaction of peptides of known and/or unknown structure and also with bulkier peptides of interest and small peptides of interest which interact with each other such that the fragments of fluorescent protein are directed away from each other or peptides of unknown structure.

Preferably at least three different linker lengths are provided. More preferably at least four, even more preferably at least five different linker lengths are provided.

In an embodiment of the protein interaction system, the system may additionally comprise at least one bait fusion protein which is identical to one of the bait fusion proteins provided by the plurality of bait fusion proteins.

A plurality of prey fusion proteins may be provided. The linker portions of at least two prey fusion proteins may be of different lengths. For example two prey fusion proteins may be provided each comprising the same protein of interest and same fluorescent fragment, but provided with linkers of different lengths e.g. 10 amino acid residues and 20 amino acids respectively.

In one embodiment the linker portions comprise in the range 5 to 60 amino acid residues, more preferably in the range 5 to 60 amino acid, yet more preferably in the range 20 to 60 amino acid residues.

In a preferred embodiment at least one of the linker portions has at least 20 amino acids.

In particular embodiments of the invention a linker may comprise greater than 25 amino acids, for example greater than 30 amino acids, greater than 35 amino acids, greater than 40 amino acids, greater than 50 amino acids or greater than 55 amino acids in length.

Preferably, the linker comprises up to 60 amino acids.

More preferably the linker comprises up to 45 amino acids.

Preferably the linker is comprised of substantially hydrophillic amino-acid residues.

More preferably at least one, preferably each of the linkers comprises multiples of a pentapeptide sequence such as glycyl-glycyl-glycyl-glycyl-serine (SEQ ID NO: 1).

Any fluorescent protein in which appropriate split sites can be formed and which the resulting fragments can associate with each other and cause fluorescence may be used in the invention. Examples of fluorescent proteins include red fluorescent protein and blue, yellow and cyan variants of GFP. Moreover, variants of GFP which have increased fluorescence may be utilised. However, in a preferred embodiment the fragments of fluorescent protein are fragments of green fluorescent protein, mutants or variants thereof.

More preferably the fluorescent protein is a humanised form of a fluorescent protein, e.g. Enhanced Green Fluorescent Protein (EGFP) or a variant thereof.

In a humanised nucleotide sequence one or more of the codons in the sequence are altered such that for the amino acid being encoded, the codon used is that which most frequently appears in humans. This is advantageous as a humanised fluorescent protein construct e.g. (EGFP) has maximised expression levels and rate of flurophore formation in mammalian cells. This makes detection of fluorescence, produced by fragments of fluorescent proteins (fluorogenic fragments) which functionally associate with each other, easier to determine.

In preferred embodiments, the fragments of fluorescent protein (fluorogenic fragments) are generatable through the introduction of a split point between the amino acids at positions 157 and 158, or (in a second embodiment) between the amino acids at positions 172 and 173 of the humanised form of Green Fluorescent Protein (SEQ ID NO 2) shown below.

SEQ ID NO 2—EGFP (Clontech Inc.) [Genebank Accession number gb:AAB02574 gi 1377912]:

1 mvskgeelft gvvpilveld gdvnghkfsv sgegegdaty

41 gkltlkfict tgklpvpwpt lvttltygvq cfsrypdhmk

81 qhdffksamp egyvqertif fkddgnyktr aevkfegdtl

121 vnrielkgid fkedgnilgh kleynynshn vyimadkqkn

161 gikvnfkirh niedgsvqla dhyqqntpig dgpvllpdnh

201 ylstqsalsk dpnekrdhmv llefvtaagi tlgmdelyk

The fluorogenic fragments generated by the introduction of a split point between the amino acid residues at positions 157 and 158, or between amino acid residues at positions 172 and 173, result in the production of hapto-EGFP^{1/157} and hapto-EGFP^{158/239}, or hapto-EGFP^{1/172} and hapto-EGFP^{173/239}, respectively.

Alternative split points are between residues 23/24, 38/39, 50/51, 76/77, 89/90, 102/103, 116/117, 132/133, 142/143, 190/191, 211/212 or 214/215 of EGFP.

Thus in preferred embodiments, the fluorogenic fragments are of amino acid residues 1 to 23, 1 to 38, 1 to 50, 1 to 76, 1 to 89, 1 to 102, 1 to 116, 1 to 132, 1 to 142, 1 to 157, 1 to 172, 1 to 190, 1 to 211 or 1 to 214, and a respective complementary fragment 24 to 239, 39 to 239, 51 to 239, 77 to 239, 90 to 239, 103 to 239, 117 to 239, 133 to 239, 143 to 239, 158 to 239, 173 to 239, 191 to 239, 212 to 239, or 215 to 239 of EGFP.

It can be envisaged that three or more fluorescent fragments may be provided by introducing two split points as discussed above into the fluorescent protein, each fragment being fused to a peptide of interest. On interaction of the peptides, the three or more fluorescent fragments are brought together such that they can functionally associate and generate a fluorescent signal capable of being detected.

In another embodiment one or more of the three fluorescent fragments can be fused to a test agent such as a small molecule, such as a metal ion. In this manner, protein interactions which require the participation of additional test agents, such as small molecules, can be detected.

In an embodiment of the system wherein a plurality of prey fusion proteins are present, additionally or alternatively to prey proteins which comprise linkers of different lengths at least two of the second peptides of interest of the prey fusion proteins may comprise different amino acid sequences.

The prey fusion peptides may be provided as a library of different peptides of interest linked to a fragment of fluorescent protein which is complementary to the fluorescent fragment of the bait fusion protein. The library may be an expression library, a library of a range of mutations of a single peptide or other peptide libraries as known in the art.

The first peptide of interest may be linked to the N terminus of the first fragment of fluorescent protein or alternatively the first peptide may be linked to the C terminus of the first fragment of fluorescent protein.

The second peptide of interest may be linked to the N terminus of the complementary fragment of fluorescent protein or alternatively the second peptide may be linked to the C terminus of the complementary fragment of fluorescent protein.

The peptides of interest linked to the fragments of fluorescent protein can be small peptides of differing amino acid sequence, for example nonomers, comprising different amino acid compositions or the same overall composition, but with the amino acids present in a different order. Alternatively, the peptides may be full size proteins e.g. obtained from a cDNA library. Peptides may be produced synthetically or recombinantly using techniques which are widely available in the art. For peptides translated in the cell, naturally or induced, post-translational modification for example glycosylation, lipidation, phosphorylation of the peptides may occur, and these post translated products are still to be regarded as peptides.

In one embodiment, the protein interaction system is a cell based interaction system.

In such a cell based system, each cell preferably comprises one bait fusion protein of a single defined linker length. For example, if three bait fusion proteins are provided each of which has a different linker length then a first cell will comprise a bait fusion protein of a first linker length, a second cell will comprise a bait fusion protein of a second linker length and a third cell will comprise a third bait fusion protein of a third linker length.

When the protein interaction system is provided as a cell based system, it may be produced using nucleic acid constructs which when expressed in live cells provide the components of the protein interaction system.

According to a second aspect of the present invention there is provided a library of nucleic acid constructs, each construct encoding
(i) a first fragment of fluorescent protein capable of functional association with a complementary fragment of fluorescent protein such that on functional association of said first and complementary fragments fluorescence is enabled,
(ii) a peptide of interest, and
(iii) a linker portion interposed between the peptide and first fragment of fluorescent protein wherein the peptide of interest encoded by each nucleic acid construct is the same and the linker portion of each construct is of a different length to the linker of each other construct.

In preferred embodiments at least one linker portion comprises at least 20 amino acids. The inventors have determined an economical and relatively easy way of providing longer (for example greater than 20 amino acids) linkers in the bait and/or prey fusion proteins by providing linkers comprising multiples of a pentapeptide sequence such as glycyl-glycyl-glycyl-glycyl-serine. Such sequences provide advantageous flexibility properties and thus enable the linker region to be readily extended to provide a robust screening method.

According to a third aspect of the invention there is provided an expression vector comprising a plurality of the constructs as provided by the second aspect of the invention.

According to a fourth aspect of the invention there is provided an expression vector comprising at least one of the plurality of nucleic acid constructs wherein the at least one nucleic acid construct encodes a fusion protein having a linker of at least 20 amino acids.

An expression vector may be introduced into a cell using any known techniques such as calcium phosphate precipitation, lipofection, electroporation and the like.

In embodiments of the invention more than one vector encoding a construct of the third or fourth aspect of the invention and/or a construct comprising a complementary fragment of fluorescent protein may be introduced to a cell based system.

According to a fifth aspect of the present invention there is provided an assay method for monitoring peptide interaction comprising the steps of
providing the protein interaction system as provided in the first aspect of the invention, and
detecting fluorescence produced by the interaction of first and second peptides of interest causing fragments of the fluorescent protein to functionally associate with each other.

In a particular embodiment the assay method is performed in vitro.

By providing fusion proteins of the protein interaction system in a cell based system or by mixing the fusion proteins of the first and second protein of interest together in vitro the assay can be used to screen a protein fusion library to identify a second peptide of interest which binds to a first peptide of interest or vice versa.

An embodiment of the assay may comprise the step of observing the subcellular location of the interaction of the first and second peptides of interest in a cell. This step is advantageous as it provides details of the location in the cell that the interaction is taking place, for example at the membrane, in the cytoplasm, or in the nucleus.

Any methods as known in the art may be used to determine the subcellular location of interaction, for example confocal scanning laser microscopy.

The assay method may further comprise the step of observing the level of fluorescence produced at a range of time points.

This step would allow determination of the subcellular dynamics of the peptide interactions visualised by fluorescence observations of living cells to enable spatio-temporal studies of peptide interactions throughout all parts of the cell cycle, for example such techniques would also allow the trafficking of interacting peptides, for example from the endoplasmic reticulum (ER) to the plasma membrane to be tracked.

The assay may comprise the step of determining the length of the linkers of those fusion proteins which allow the first fragment and complementary fragment of the fluorescent protein to functionally complement each other and enable fluorescence to be detected on interaction of the first and second proteins of interest.

In such an embodiment the assay method may comprise the steps of
providing the protein interaction system as provided in the first aspect of the invention,
detecting fluorescence produced by the interaction of the first and second peptides of interest causing fragments of the fluorescent protein to functionally associate with each other,
selecting those cells in which fluorescence is detected,
clonally amplifying the cells in which fluorescence is detected, and
determining the length of the linkers in said cells by DNA sequencing.

Determination of the linker length of those fusion proteins which interact with each other may be advantageous as the distribution of occurrence of linker lengths obtained from those cells in which fluorescence is observed should indicate a sharp cutoff at the lower limit of linker lengths reflecting the minimum linker length capable of spanning the separation of the fusion termini of the interacting peptides. This in turn can be used to provide a value of the distance between the interacting peptides in Ångstroms on the basis that each amino acid residue contributes 3.7 Å to the length of each linker in an extended backbone conformation.

An embodiment of the assay may comprise the further step of isolating those fusion proteins which are determined as allowing the first fragment and complementary fragment of the fluorescent protein to functionally complement each other and enable fluorescence to be detected on interaction of the first and second peptides of interest.

Isolation may be achieved for example using a fluorescence activated cell sorting machine or laser microdissection.

In a particular embodiment of this assay laser excision of cell, amplification of the construct and sequencing may be used to allow the linker lengths of those bait and/or prey fusion proteins of interest which interact to cause fluorescence to be determined and thus indicate the minimum distance of the attachment points of the peptides of interest.

The isolated cells and fusion proteins may be subjected to further analysis, for example sequencing of the interacting peptides. The sequenced peptides may then be compared with sequences (full length or partial) in a databank so as to identify or characterise the interacting peptide isolated from the cell.

The sequences of the interacting peptides may alternatively be inferred by cloning selected fluorescent cells and subjecting the cloned cells to e.g. PCR amplification and DNA sequencing. These sequences can then be cloned into expression vectors and the protein expressed and purified. The purified protein can be further studied or used for example in research.

The assay may be used to determine if test agents are capable of promoting or enhancing interaction of peptides or alternatively of preventing or inhibiting the interaction of peptides.

In such an embodiment the assay may comprise the steps of
providing the protein interaction system as provided in the first aspect of the invention,
detecting the level of fluorescence produced by the interaction of the first and second peptides of interest causing fragments of the fluorescent protein to functionally complement each other,
providing a putative interaction modulating agent, and
detecting the level of fluorescence produced in the presence of said putative modulating agent, wherein detection of fluorescence in the absence of the putative modulating agent, but not in the presence of the putative modulating agent is indicative that the putative modulating agent prevents or is an inhibitor of peptide interaction and the detection of fluorescence in the presence of the putative modulating agent, but not in the absence of the putative modulating agent is indicative that the putative modulating agent promotes or enhances peptide interaction.

The detected fluorescence may be quantitatively determined such that fluorescence produced by different cells or under different conditions can be compared.

For example, in testing the effects of a putative modulating agent, any detected fluorescence may be measured in the absence and presence of the putative modulating agent wherein a reduction in fluorescence in the presence of said modulating agent compared to fluorescence in the absence of said candidate modulating agent is indicative of inhibition of complex formation by the modulating agent and an increase in fluorescence is indicative of promotion or enhancement of complex formation by the modulating agent.

Modulation of the interaction between peptides may be a desirable outcome in the treatment of certain clinical conditions, or as a research tool to study peptide to peptide interactions. For example, modulation of peptide to peptide interactions may facilitate the task of determining the steps of complex pathways by the provision of means to promote or inhibit a specific interaction, allowing the effects of other proteins to be studied in better detail.

Many peptide to peptide interactions require the participation of small molecules or peptides. Such a requirement can be determined by simply adding small molecules or peptides to a cell based system or to an in vitro mixture containing the fusion proteins of the interaction system and performing an assay as described above to determine if these small molecules or peptides modulate the interaction of the peptides of interest as determined by detection or measurement of an alteration in fluorescent signal.

Thus, embodiments of the assay of the present invention can be used to select compounds capable of triggering, stabilising or destablising peptide to peptide interactions. Embodiments of the assay method as described herein may be used to screen for example, a receptor agonist, a receptor antagonist, protein inhibitors, or an inhibitor of protein to protein interactions.

As will be apparent, the assay of the present invention can be applied in a format appropriate for large scale screening, for example, combinatorial technologies can be employed to construct combinatorial libraries of small molecules or peptides to test as modulating agents.

Preferably, structural information on the peptide to peptide interaction to be modulated is obtained by testing different agents to determine if they are modulating agents.

For example, each of the interacting pair can be expressed and purified and then allowed to interact in suitable in vitro conditions. Optionally the interacting peptides can be stabilised by crosslinking or other techniques. The interacting complex can be studied using various biophysical techniques such as X-ray crystallography, NMR, or mass spectrometry. In addition, information concerning the interaction can be derived through mutagenesis experiments for example alanine scanning, or altering the charged amino acids or hydrophobic residues on the exposed surface of the bait or prey peptide being tested.

Based on the structural information obtained, structural relationships between the interacting peptides as well as between the modulating compound and the interacting peptides can be elucidated. Further, the three dimensional structure of the interacting moieties and/or that of the modulating compound can provide information to determine suitable lead compounds able to modulate interaction, which medicinal chemists can use to design analog compounds having similar moieties and structures.

In a sixth aspect of the present invention there is provided novel compounds obtained using an assay of the invention.

Modulator compounds obtained according to the method of invention may be prepared as a pharmaceutical preparation or composition.

Such preparations will comprise the modulating compound and a suitable carrier, diluent or excipient. These preparations may be administered by a variety of routes, for example, oral, buccal, topical, intramuscular, intravenous, subcutaneous or the like.

According to an seventh aspect of the present invention there is provided a kit comprising nucleic acid constructs as provided in the second aspect of the invention and means to express the constructs.

The kit may further comprise candidate modulating agents, which promote, enhance, prevent or inhibit peptide interaction.

The kit may further comprise nucleic acids which encode at least one complementary fragment of fluorescent protein, at least one second peptide of interest and a second linker portion interposed between the complementary fragment and the second peptide of interest.

In another embodiment the kit comprises a cell in which a vector comprising constructs of the second aspect of the invention can be expressed.

The kit may comprise a plurality of second peptides of interest of different amino acid sequences linked to a complementary fragment of fluorescent protein.

Additionally, the kit may include instructions for using the kit to practice the present invention. The instructions should be in writing in a tangible form or stored in an electronically retrievable form.

Preferred features of each aspect of the invention are as for each of the other aspects mutatis mutandis unless the context demands otherwise.

Unless otherwise defined, all technical and scientific terms used herein have the meaning commonly understood by a person who is skilled in the art in the field of the present invention.

Throughout the specification, unless the context demands otherwise, the terms ‘comprise’ or ‘include’, or variations such as ‘comprises’ or ‘comprising’, ‘includes’ or ‘including’ will be understood to imply the inclusion of a stated integer or group of integers, but not the exclusion of any other integer or group of integers.

Unless the context demands otherwise, the term peptide, polypeptide and protein are used interchangeably to refer to amino acids in which the amino acid residues are linked by covalent peptide bonds or alternatively (where post-translational processing has removed an internal segment) by covalent di-sulphide bonds, etc. The amino acid chains can be of any length and comprise at least two amino acids, they can include domains of proteins or full-length proteins. Unless otherwise stated the terms, peptide, polypeptide and protein also encompass various modified forms thereof, including but not limited to glycosylated forms, phosphorylated forms etc.

The term interaction or interacting as used herein means that two entities, for example, distinct peptides, domains of proteins or complete proteins, exhibit sufficient physical affinity to each other so as to bring the two interacting entities physically close to each other. An extreme case of interaction is the formation of a chemical bond that results in continual, stable proximity of the two entities. Interactions that are based solely on physical affinities, although usually more dynamic than chemically bonding interactions, can be equally effective at co-localising independent entities. Physical affinities include, but are not limited to, for example electrical charge differences, hydrophobicity, hydrogen bonds, van der Waals force, ionic force, covalent linkages, and combinations thereof. The interacting entities may interact transiently or permanently. Interaction may be reversible or irreversible. In any event it is in contrast to and distinguishable from natural random movement of two entities. Examples of interactions include specific interactions between antigen and antibody, ligand and receptor etc.

### BRIEF DESCRIPTION OF THE FIGURES

The present invention will now be described with reference to the following non-limiting examples and with reference to the figures, wherein:

FIG. 1a is a ribbon diagram of EGFP;

FIG. 1b is an illustration of the split points and the related sequences surrounding these split points of EGFP;

FIG. 2 is a representation of a hapto-EGFP with a range of linker lengths between the bait peptide and respective fluorogenic fragment and a plurality of peptides linked to a complementary fluorogenic fragment;

FIG. 3 shows fluorescent images of Vero cells transiently cotransfected with haptoEGFP expression constructs, (A) Cells cotransfected with pN157(6)zip and pzip(4)C158 in which a functional leucine zipper mediates the association of haptoEGFP1-157 and haptoEGFP158-238 to generate fluorescence, (B) Negative control cotransfection using pN157(6) and p(4)C158 which lack sequences encoding the leucine zippers and as such fail to generate fluorescence, (D) Cells cotransfected with pN172(6)zip and pzip(4)C173 in which a functional leucine zipper mediated association of haptoEGFP1-172 and haptoEGFP173-238 occurs to generate fluorescence which is of greater intensity to that observed with the 157/158 split point (E) Negative control cotransfection using pN172(6) and p(4)C173 which lack sequences encoding the leucine zippers and as such fail to generate fluorescence, (C and F) Confocal images of cotransfected cells from (A) and (D) showing the intracellular localisation of fluorescence-Vero cells were cotransfected with plasmids encoding linkers ranging in length from 4 to 26 amino acids and UV images were collected at 24 hours post-transfection using identical exposure times, (G) pN157(6)zip and pzip(4)C158 (H) pN157(16)zip and pzip(14)C158 (I) pN157(26)zip and pzip(24)C158 (J) pN157(26)zip and pzip(4)C158 (K) pN157(6)zip and pzip(24)C158 (L) a negative untransfected control illustrates the background fluorescence level (Italicised figures in brackets indicate the length of the hydrophilic linker); and

FIG. 4 shows the importance of relative orientations of the haptoEGFP and binding proteins—FIG. 4A illustrates the case of associating membrane proteins where a Type I and Type II protein combine, both hapto.EGFP moieties must be on the same side of the membrane barrier for their combination, association of membrane proteins of the same type suffer from the same constraints (FIG. 4b) wherein to obtain fluorescence fusion to the appropriate (cytoplasmic) terminus of the binding protein is to the same type of terminus on both haptoEGFPs (ie: N and N′ or C and C′, for Type II and Type I respectively)

Functional association of fragments of fluorescent proteins, brought together by the interaction of peptides fused to the fragments to screen for peptide to peptide interactions requires that the fragments reliably functionally associate only after interaction of the fused peptides. Fluorescence may be measured by suitable method known to a person skilled in the art, for example, fluorescence spectrometry, luminescence spectrometry, fluorescence activated cell analysis, fluorescence activated cell sorting automated microscopy or automated imaging.

Reliable functional association has to date not been achieved due to the possibility of steric hindrance and steric constraints on the functional association of haptoFPs when bulky proteins are associated to the fluorescent protein fragments due to too short linkers being interposed between the peptide of the interest and the fragment of fluorescent protein or too much flexibility due to too long a linker being interposed between the same.

The inventors have determined an economical and reliable method to provide a range of bait fusion proteins comprising a linker region of varying length and thus provide a robust screening interaction system and method.

This minimises the problems of steric hindrance, as a peptide of interest is provided with both considerable flexibility due to the presence of long linkers, but also ensures that short linkers are present such that the fragments of fluorescent protein are brought into close proximity with each other. Thus the chance of a false negative result being obtained, i.e. finding that the peptides of study do not bind when in fact they do, is reduced.

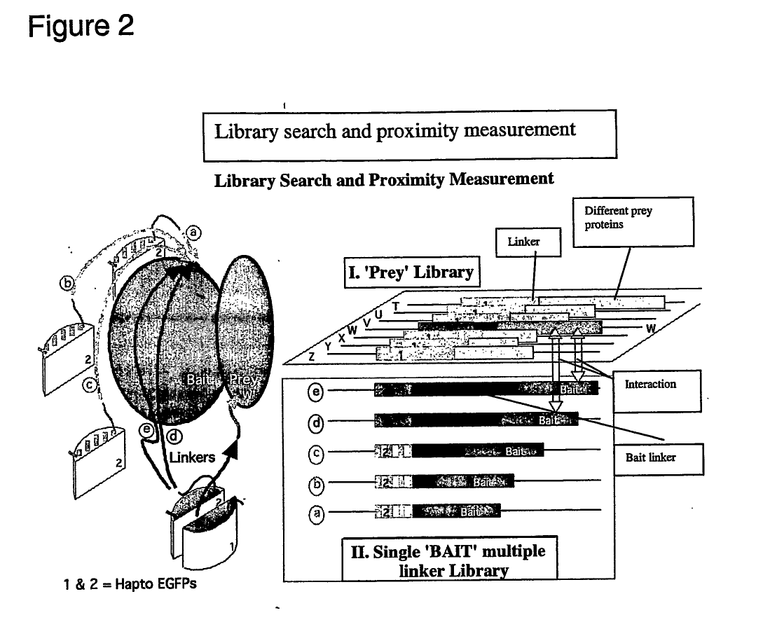

A general description of the principle of the invention is shown in FIG. 2 using haptoEGFPs as the fluorescent fragments.

As shown in FIG. 2 protein to protein interaction searches can be conducted by library interrogation. The two peptides being tested for interaction are designated bait and ‘prey’ “W”. Two libraries are generated (I and II), one series of constructs (here designated T . . . Z, library I, >10,000 members) encodes a hapto-EGFP followed by a DNA sequence encoding a 60 residue linker attached to the 5′-end of a cDNA library, which contains the gene encoding the ‘prey’, “W” here. The second series of constructs (a . . . e here, library II, <20 members) encodes the complementary hapto-EGFP followed by a degenerate linker DNA sequence and the ‘bait’ gene. All arrows indicate the direction of the polypeptide backbone (N->C).

A. ‘Prey’ identification: co-transfection with the ‘prey’ library (I) and construct ‘e’ (long linker—preferably 60 amino acid residues) from the ‘bait’ library (II) generates fluorescent cells when the recipient cell receives a vector from library (I) bearing the ‘W’ gene (in this case) and a second vector bearing the ‘e’ bait construct. Clonal expansion of these fluorescent cells allows identification of gene ‘W’.

B. Proximity measurement: The clone(s) from step A are co-transfected with the ‘bait’ library (II). In this case cells showing fluorescence synthesise interacting proteins with a sufficiently long linker to allow productive complementary hapto-GFP interaction. (‘d’ or ‘e’ in this case), as shown to the left of the diagram. The hollow arrows in the right hand part of the diagram are intended to indicate that the interaction of the gene products with these two constructs generates fluorescence, while other interactions between the product of gene ‘W’ and the bait protein do not give rise to fluorescent cells due to insufficient length of linker.

Generation of Fluorescent Fragments

Fluorescent fragments may be provided by any means known in the art. A first fragment of fluorescent protein may be an N terminal fragment of fluorescent protein, e.g. GFP, comprising a substantially continuous stretch of amino acids from amino acid number 1 to amino acid X of fluorescent protein and a second fragment may be a substantially continuous stretch of amino acids from X+1 to around the C terminal end of the fluorescent protein (e.g. amino acid 238 of GFP), wherein the bond between residue X and X+1 typically is located in a hydrophilic loop region of the fluorescent protein. Should greater than two fragments of fluorescent protein require to be generated for use in assay methods where three or more fragments of fluorescent protein are linked to proteins of interest then a N terminal fragment may comprise a substantially continuous stretch of amino acids from amino acid number 1 to amino acid X of fluorescent protein, a second fragment can be considered as a substantially continuous stretch of amino acids from X+1 to residue Y and a third fragment may be provided by a substantially continuous stretch of amino acids from Y+1 to around the C terminal end (e.g. amino acid 238) of fluorescent protein. In such an example the bonds between X and X+1 and Y and Y+1 will be located in hydrophilic loop regions of fluorescent protein.

Generation of Linkers

As shown in FIG. 2, multiple bait fusion peptides may be created with linkers of differing lengths.

To enable economical extension of a linker, to provide linkers of differing lengths, each linker may be created using overlapping oligonucleotides encoding repeating (GGGGS), units wherein the linker oligonucleotide is engineered to carry a unique restriction site, for example unique Sac I and BamHI restriction sites, present in a core expression vector, for example pN^{EGFP}(Sac)zip and pzip(Bam)C^{EGFP} (Sac I for the hexapapeptide and BamH I for the tetrapeptide in example 2).

This allows the insertion of synthetic oligonucleotides encoding further flexible hydrophilic linker sequences of the form (GGGGS)N with the appropriate 5′ and 3′ sticky ends to distance the binding peptides (for example leucine zippers—see example 2) away from the signalling haptoEGFPs.

Once prepared the constructs may be sequenced before transfection to confirm correct orientation of the insert.

Further as illustrated in FIG. 2, a library of prey fusion peptides may be provided wherein the linkers of the prey fusion peptides are of the same length, but different second peptides of interest are fused to the linker region fused to the complementary fragment of fluorescent protein.

In general to prepare a library of fusion proteins of unknown library sequences, the sequence encoding the hapto-EGFP is fused to the 5′ end of the peptide library due to the presence of downstream stop codons in the cDNA.

If the gene sequence encoding the protein is unknown, constructs are required to be generated for all three reading frames to ensure that one is in the correct reading frame.

The cDNA sequences should be obtained from a source which permits directional cloning into restriction sites which are extremely rare in mammalian DNA. Suitable sequences may be found in the Large-Insert cDNA library (Clontech).

In particular embodiments a core panning vector may be engineered from existing plasmids to contain a CMV promoter, an initiation codon, sequences encoding a hapto-EGFP, an intervening linker, an Sfi IA site and an Sfi IB site, a stop codon and an SV40 polyadenylation signal. Two additional screening vectors may be generated to include one and two extra nucleotides between the linker and the Sfi IA site to correct the reading frame. cDNA fragments, flanked with Sfi IA and Sfi IB sites obtained from the library are cloned downstream of the optimised hapto-EGFP linker constructs. The hapto-EGFP library is then transfected into suitable cells, for example CHO cells and a mixed population of cells selected using G418 and passaged to confluency

Where interaction between the peptides being screened occurs and the linkers allow association of the fragments of fluorescent protein, fluorescence is generated.

Any cells which fluoresce may then be isolated by fluorescent laser microdissection and single cell RT-PCR performed to identify mRNA which encodes peptides which interact with the cytoplasmic tails of the receptor molecules.

### EXAMPLE 1

### Generation of GFP Fragments

The GFP fragments of the interaction system capable of functional association were generated by split points at various points along the 239 residue length of the GFP protein, resulting in the generation of new C′ and N′ termini which, in three dimensions, are located at the top and at the base of the beta-can structure.

Split points were introduced based on a structure driven approach between hydrophilic residues.

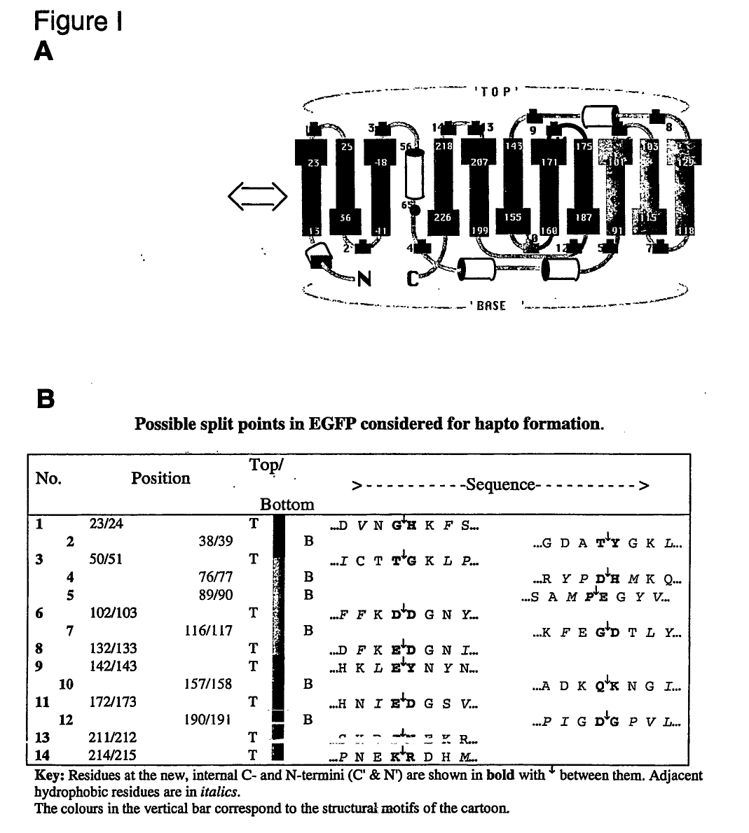

As shown in FIG. 1 the beta-can topology of EGFP is formed by the eleven strands of the beta structure. This structure is characterised by forming three instances of a tripartite antiparallel sheet motif joined edge to edge around the periphery of the ‘can’, with the remaining two beta strands completing the cylindrical structure. The most successful split points obtained to date occur in the third tripartite motif between hydrophilic residues allowing adjacent hydrophobic side chains to promote refolding of the haptoGFPs.

As shown in the non exhaustive list of Table 1 a number of split points were identified using the above approach. It would appear that each split point in Table 1 is simply one example of a range of potentially useful split points, the range being shown in parentheses of Table 1.

TABLE 1

| | Residue | |
|---|---|---|
| Split point | position in | Possible |
| Number | EGFP | range |
| 1 | 23/24 | (23-25) |
| 2 | 38/39 | (36-41) |
| 3 | 50/51 | (48-54) |
| 4 | 76/77 | (75-91) |
| 5 | 89/90 | (75-90) |
| 6 | 102/103 | (101-103) |
| 7 | 116/117 | (115-118) |
| 8 | 132/133 | (129-143) |
| 9 | 142/143 | (129-143) |
| 10 | 157/158 | (155-160) |
| 11 | 172/173 | (171-175) |
| 12 | 190/191 | (187-199) |
| 13 | 211/212 | (207-218) |
| 14 | 214/215 | (207-218) |

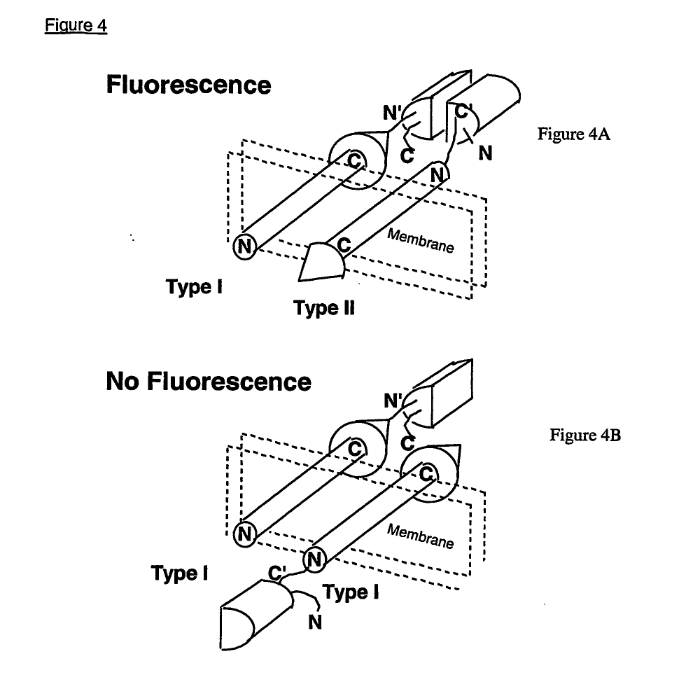

To extend the versatility of the hapto-EGFP method, constructs were created where instead of using C′ and N′ for the attachment of heterologus proteins, the endogenous termini, N or C, together with one of the new N′ or C′ termini were used (C′ and N′ are those N and C termini created on splitting the GFP protein into fragments, C′ is thus equivalent to the new C terminal produced on the first fragment and N′ is equivalent to the new N terminal produced on the complementary fragment). Using this technique the bait and prey peptides were added such that they were orientated to the associated fluorogenic fragments in the same direction as each other, for example both peptides of interest were attached to the bottom of the β-can structure of GFP or in the opposite direction, for example the bait peptide was attached to the bottom of the β-can structure of GFP, while the prey protein was attached to the top of the β-can structure of GFP. As shown in FIGS. 4 A & B, as peptides interact with each other in a particular orientation, then the direction of the linkage of the peptide to the N, N′, C or C′ end of the fluorogenic fragment may be important in certain circumstances so as to allow the fluorescent protein fragments to functionally interact following interaction of the peptides.

### EXAMPLE 2

To determine the effect of varying the length of the intervening hydrophilic linkers interposed between complementary fragments of fluorescent protein and leucine zipper proteins known to bind to each other the linkers were empirically increased in length in decapeptide units using the general method detailed above to modify linkers of both pN¹⁵⁷(6)zip and pzip(4)C¹⁵⁸ to increase the linker by 10, 20, 30 and 40 residues by the insertion of complementary oligonucleotides with Sac I and BamH I sites to generate in the case of the N¹⁵⁷(6)zip chimera, to 16, 26, 36 and 46 and, in the case of the complementary zip(4)C¹⁵⁸ chimera, to 14, 24, 34 and 44 residues.

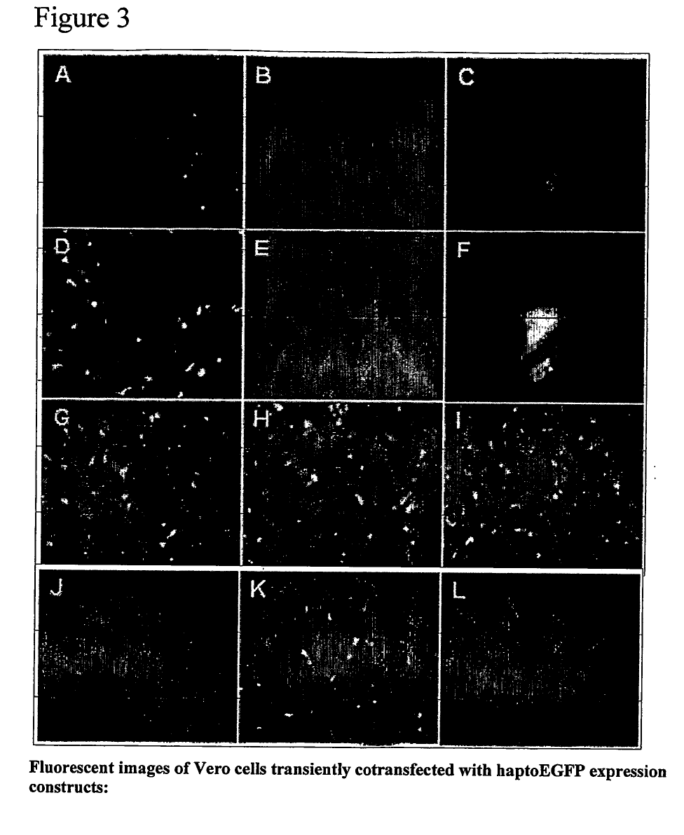

The results of this study are shown in FIG. 3.

No significant differences in the levels of fluorescence were observed when the hydrophilic spacers were lengthened by up to 26 and 24 amino acids respectively. However, the signal increased when spacers of 36 and 34 separated the leucine zipper and the haptoEGFP moieties, whereas the signal decreased when linkers comprised of 46 and 44 amino acids were introduced.

### EXAMPLE 3

Utilisation of MV H as a model homo-oligomerising transmembrane glycoprotein

In order to demonstrate that this approach can be used for a wider range of applications than current reporter systems the membrane glycoproteins of Measles Virus (MV) were examined.

Measles virus (MV) infection is mediated by a complex of two viral envelope proteins, haemagglutinin (H) glycoprotein and fusion (F) glycoprotein that bind to each other and then complex with surface receptors to aid the fusion of the virus with the plasma membrane. The H glycoprotein is dimerised in the endoplasmic reticulum and is thought to exist on the cell surface as a tetramer (dimer of dimers). The fusion (F) glycoprotein, is synthesised as an inactive precursor (F₀) which is a highly conserved type I transmembrane glycoprotein of about 60 kDa, which is cleaved by furin in the trans-golgi to yield the 41 kDa (f₁) and the 18 kDa (f₂) disulphide-linked activated F-protein. Infection of the measles virus is dependent on the interaction of the F/H complex with cell surface receptors.

Two constructs, which expressed N157(16)MV-H and C158(14)MV-H, were initially generated in order to investigate homodimerisation of a type II membrane glycoprotein of unknown structure. The linker regions of these constructs were generated using overlapping oligonucleotides which contain Sfi IA and Sfi IB restriction sites were introduced into pN^{1/157}(16)zip and pC^{158/239}(14)zip constructs. These chimeras differ from those generated from the leucine zippers in that the first has H fused to the C′ terminus, while the second employs the endogenous C terminus for fusion. Expression of the chimeric proteins was detected by immunoblotting cell lysates using peptide antiserum raised against EGFP (results not shown). This demonstrated that the haptoEGFP tagged H glycoproteins were stably expressed in the transfected cells. Furthermore, the electrophoretic mobility of the chimeric proteins suggested that they were correctly glycosylated. Fluorescence was readily detected in living cells and all of the necessary controls demonstrated that the association of the haptoEGFPs was specifically driven by the dimerisation of the H glycoproteins. Fluorescence was absent from the nucleus but was clearly demonstrable from the ER through the Golgi to the plasma membrane of the cells.

It is clear that this methodology could be used to identify further, membrane receptor proteins which interact with the H protein as could cytoplasmic proteins which interact with known MV receptors and which may therefore initiate downstream signalling events.

### EXAMPLE 4

In order to ascertain that the haptoEGFP tagged glycoproteins were capable of forming a biologically active complex at the cell membrane cells were transfected with constructs expressing a number of different H and F chimeras. Firstly the bioactivity of the H chimeras was investigated by co-transfection with a plasmid expressing the unmodified F glycoprotein. Initially cell-to-cell fusion was readily detected 2 d.p.t. in cells expressing N157(16)MV-H, C158(14)MV-H, and F.

Multi-nucleated syncytia comprised of more that 50 cells were obtained which were easily discernible by phase-contrast microscopy.

Fluorescence was detected by vital confocal laser microscopy in all syncytia, their size was comparable to that obtained by co-expression of unmodified MV F and H.

By three days post-transfection, cell-to-cell fusion was detected over large areas of the monolayer and many syncytia comprised of over 200 individual cells. Confocal scanning laser microscopy was used to determine whether localised fluorescence was present within the syncytia and series of images were collected. Composite images were generated and fluorescence localization was examined in the x/z and y/z planes. Fluorescence was detected in the perinuclear regions and also in a honeycomb lattice which is consistent with the presence of the glycoprotein in the ER and Golgi.

When the plasma membrane was examined in x/z and y/z it was difficult detect a discrete line of fluorescence in single sections. However, small 1-5 μm vesicles with fluorescent membranes were frequently detected at the cell surface. These vesicles are very reminiscent of budding virions and are approximately 10 times larger than MV virions.

These co-transfected cells were fixed in order to examine the intracellular localisation of fluorescence within syncytia at higher magnifications. In the fixed cells it was also clear that the fluorescence was present in the ER and Golgi as expected. However, areas of localised fluorescence were also detected at the periphery of the syncytia where the fused cells came into contact with the surrounding cells, suggesting that the H glycoprotein dimers are not evenly distributed on the plasma membrane and these accumulations could be sites of fusion pore formation where the H glycoproteins are in close contact with the cellular receptor, in this case CD46.

The extracellular localisation of the H dimers was also examined by indirect immunofluorescence using an anti-H MAb on unpermeabilised cells. This vital immunostaining indicated that a significant percentage of the dimeric H chimera had been correctly processed and trafficked to the cell membrane where, in view of the size of the syncytia, it was clearly functional. Fluorimetery was used to determine if the fluorescence could be detected and quantified. In cells transfected for defined periods of time it was found that syncytia formed. Fluorescent signals were detected which were equivalent to those obtained in pN157(6)zip and pzip(4)C158 co-transfected cells. No signals were obtained when the construct which expressed C158(14)MV-H was replaced by one encoding zip(14)C158 indicating that the specific association of the H glycoproteins was driving the haptoEGFP moieties into close enough proximity to enable the generation of the fluorophore.

Although the invention has been particularly shown and described with reference to particular examples, it will be understood by those skilled in the art that various changes in the form and details may be made therein without departing from the scope of the present invention.

1. A protein interaction system comprising
a plurality of bait fusion proteins, each fusion protein comprising (i) a first fragment of fluorescent protein, a first peptide of interest and a linker portion interposed between the first peptide and first fluorescent fragment; wherein the linker portions of each bait fusion protein are of different lengths, and the first peptide of interest of each bait fusion protein is identical to the first peptide of interest in each of the other bait fusion proteins,
and (ii) at least one prey fusion protein comprising a fragment of fluorescent protein complementary to said first fragment of fluorescent protein, a second peptide of interest and a second linker portion interposed between the complementary fragment and the second peptide;
wherein, on interaction of a first peptide of interest with a second peptide of interest, the fragments of the fluorescent protein functionally associate to promote fluorescence.

2. The protein interaction system as claimed in claim 1 wherein the linker portions comprise in the range 5 to 100 amino acid residues.

3. The protein interaction system as claimed in claim 2 wherein at least one linker portion comprises at least 20 amino acids.

4. The protein interaction system according to claim 1, wherein the fragments of fluorescent protein are generatable through the introduction of a split point between the amino acids at positions 157 and 158, or between the amino acids at positions 172 and 173 of the humanised form of Green Fluorescent Protein (SEQ ID NO 2).

5. The protein interaction system as claimed in claim 1, wherein the system comprises a plurality of prey fusion proteins.

6. The protein interaction system as claimed in claim 5 wherein the linker portions of at least two prey fusion proteins are of different lengths.

7. The protein interaction system as claimed in claim 5 wherein at least two of the second peptides of interest of the prey fusion proteins are provided by different amino acid sequences.

8. The protein interaction system as claimed in claim 1, wherein the first peptide is linked to the N terminus of the first fragment of fluorescent protein.

9. The protein interaction system as claimed in claim 1, wherein the first peptide is linked to the C terminus of the first fragment of fluorescent protein.

10. The protein interaction system as claimed in claim 1, wherein the second peptide is linked to the N terminus of the complementary fragment of fluorescent protein.

11. The protein interaction system as claimed in claim 1, wherein the second peptide is linked to the C terminus of the complementary fragment of fluorescent protein.

12. The protein interaction system as claimed in claim 1, further comprising at least a third fusion protein comprising at least a third fragment of fluorescent protein complementary to a first and/or second complementary fragment of fluorescent protein;
wherein said at least third fragment is linked to at least a third peptide of interest and at least a third linker is interposed between the at least third fragment and at least third peptide of interest wherein the at least third fragment of fluorescent protein is capable of functional association with a first and/or complementary fragment of fluorescent protein such that on functional association of said fragments fluorescence is enabled and on interaction of the first, second and third peptides of interest the fragments functionally complement each other to promote fluorescence.

13. A protein interaction system as claimed in claim 1, wherein the system is a cell based system.

14. A library of nucleic acid constructs comprising a plurality of nucleic acid constructs, each construct encoding
(i) a first fragment of fluorescent protein capable of functional association with a complementary fragment of fluorescent protein such that on functional association of said first and complementary fragments fluorescence is enabled,
(ii) a peptide of interest and
(iii) a linker portion interposed between the peptide and first fragment of fluorescent protein;
wherein the peptide of interest encoded by each nucleic acid construct is the same and the linker portion encoded by each construct is of a different length to the linker encoded by each other construct.

15. The library according to claim 14, wherein the linker portions comprise in the range 5 to 100 amino acid residues.

16. The library as claimed in claim 14 wherein at least one linker portion comprises at least 20 amino acids.

17. The library according to claim 14, wherein the fragments of fluorescent protein are generatable through the introduction of a split point between the amino acids at positions 157 and 158, or between the amino acids at positions 172 and 173 of the humanised form of Green Fluorescent Protein (SEQ ID NO 2).

18. An expression vector comprising at least one of the plurality of nucleic acid constructs as defined in claim 14, wherein the at least one nucleic acid construct encodes a fusion protein having a linker of at least 20 amino acids.

19. An expression vector comprising a plurality of nucleic acid constructs as defined in claim 14.

20. The expression vector according to claim 19, wherein at least one nucleic acid construct encodes a fusion protein having a linker of at least 20 amino acids.

21. A cell transformed with a vector as claimed in claim 18.

22. A cell comprising a protein interaction system as claimed in claim 1.

23. The cell according to claim 22, wherein the cell is transformed with a vector according to claim 18.

24. An assay method for monitoring peptide interaction comprising the steps of
(i) providing the protein interaction system of claim 1;
(ii) allowing the bait fusion proteins to come into contact with the prey fusion protein(s); and
(iii) measuring fluorescence produced by the interaction of a first and second peptide of interest causing fragments of the fluorescent protein to functionally interact.

25. The assay method according to claim 24, wherein the assay is a cell-based assay.

26. The assay method according to claim 25, wherein the cell based assay is performed using one or more cells according to claim 22.

27. The method according to claim 25, wherein the assay further comprises the step of determining the subcellular location of the interaction of the first and second peptides of interest in the at least one cell.

28. The method according to claim 24, wherein the assay further comprises the step of determining the length of the linker(s) of those fusion proteins which allow the first fragment and complementary fragment of the fluorescent protein to functionally complement each other and enable fluorescence to be detected on interaction of the first and second peptide of interest.

29. The method according to claim 24, wherein the assay comprises the steps of:
providing a putative interaction modulating agent;
measuring the fluorescence produced in the presence of said putative modulating agent;
comparing the measured fluorescence in the presence of the putative modulating agent with the measured fluorescence in the absence of the putative modulating agent;
wherein a decrease in detection of fluorescence in the presence of the putative modulating agent relative to in the absence of the putative modulating agent is indicative that the putative modulating agent prevents or is an inhibitor of peptide interaction; and wherein an increase in detection of fluorescence in the presence of the putative modulating agent relative to in the absence of the putative modulating agent is indicative that the putative modulating agent promotes or enhances peptide interaction.

30. A kit comprising a library of nucleic acid constructs according to claim 14 and means to express the constructs.

31. The kit according to claim 30 which further includes at least one second nucleic acid construct which encodes a complementary fragment of fluorescent protein, a second peptide of interest and a second linker portion interposed between the complementary fragment and the second peptide of interest.

32. The kit as claimed in claim 31 wherein the kit comprises a plurality of second nucleic acid constructs, wherein the second peptides of interest encoded by the plurality of second nucleic acid constructs are each of different amino acid sequence.
